(19) United States
(12) Patent Application Publication
(10) Pub. No.: US 2003/0006320 A1
(43) Pub. Date: Jan. 9, 2003

(54) Material spreader arrangement for a truck mounted hopper

(76) Inventors: Charles D. Swift, Kensington, NH (US); Christopher Rider, Ipswich, MA (US)

Correspondence Address: Donald N. Halgren, 35 Central Street, Manchester, MA, 01944, US

(21) Appl. No.: 09/736,923

(22) Filed: Dec. 14, 2000

(51) Int. Cl. B05D 1/00

(52) U.S. Cl. 239/675; 239/672; 239/681; 239/676; 239/1; 239/679

(57) ABSTRACT

The present invention relates to a granular material transport mechanism for a sand truck. The material mechanism is arranged in granular material flow communication with a granular material hopper, and is disposed on its lower side thereof, for distribution of said granular material from a spreader on the truck. The mechanism comprises an elongated containment housing for enclosing a rotary feed shaft. The rotary feed shaft has longitudinal ends that extend beyond the housing. A plurality of spaced-apart semicircular plates are disposed on the shaft. A bearing support for the feed shaft is arranged adjacent each longitudinal end of the feed shaft and outside of the containment housing. An opening on a rear lower side of the containment housing for permits the communication the granular material to the spreader arranged therebeneath.

### BACKGROUND OF THE INVENTION

1. Field of the Invention

This invention relates to material spreaders for use in hoppers of trucks, as may be utilized for spreading diverse particulate material therefrom.

2. Prior Art

Sand and salt trucks are common on the nation's highways during the winter months. These trucks have frames on which a sand and salt carrying hopper is supported. These hoppers have sloped sidewalls which permit the sand and salt to move downwardly towards a transport mechanism which moves the sand and salt to a spreader typically at the rear of the hopper and the rear of the truck. The sand and salt material transport mechanism of the prior art typically is a conveyor belt whose surface rolls rearwardly carrying the sand and salt to the spreader mechanism thereat. Such conveyor mechanism has rollers and bearings supporting that belt. As can be imagined, the sand and salt do these mechanisms no good. Such belt system transport mechanisms contain too many parts, are somewhat complicated and require high maintenance. The bearings that support the belt are in the sand and salt environment. Often angle iron may be attached to the belt to scoop the sand and salt material therealong. Such angle iron may also be attached to a chain, much like a bicycle chain. Such a chain is supported by sprockets and gears which are themselves exposed to the sand and salt material. Such a harsh environment does not permit a long life to such transport mechanisms.

A transport mechanism of the conveyor type is shown in U.S. Pat. No. 5,466,112 to Feller showing a combined dump truck and spreader apparatus. A first and second conveyor arrangement is disposed within the truck body. U.S. Pat. No. 4,266,731 to Musso, Jr. shows a dump spreader arrangement. U.S. Pat. No. 4,157,150 to Hetrick shows a hopper arranged with a material spreader. The material spreader in this patent comprises an arbor rotating about an axis to move material through the hopper toward one end thereof. While these means are sufficient to move material from the hopper, they are somewhat complicated, have critical components that are deleteriously affected by the sand and salt material that they carry and therefore have short life spans.

It is an object of the present invention to improve the material carrying equipment found in hoppers, of the prior art.

It is a further object of the present invention to provide a transport means for a material spreader apparatus, which is unaffected by the material which it transports from the hopper to the spreader mechanism.

It is a still further object of the present invention, to provide a transport mechanism which is simple to operate, simple to manufacture, require less maintenance and less be costly than the prior art.

### BRIEF SUMMARY OF THE INVENTION

The present invention relates to a granular material transport arrangement for use in supplying material such as sand and salt or fertilizer from a tub or hopper to a spreader attached to that hub or hopper. The hopper of the present invention is typically arranged on an elongated frame and may be mounted on a wheeled vehicle such as a sand truck. The hopper is comprised of an elongated enclosure having a front sloped wall, a first side sloped wall and a second side sloped wall and a rear sloped wall, each having a lowermost edge that defines an elongated rectangular slot. Each sloped wall has an uppermost edge that defines the periphery of an open portion for the loading of granular material within the hopper.

The elongated rectangular slot defines an opening for the transport mechanism arranged at the lowermost portion of the elongated hopper.

A plurality of side support rails may be arranged between the respective side sloped side walls and the elongated frame of the unit which is arranged on the truck bed, to properly support and hold the hopper thereon.

The transport mechanism is enclosed within a generally cylindrically shaped transfer mechanism housing which extends from a front end of the frame to the rearward end of the frame. An elongated rotary feed shaft extends longitudinally through the transfer mechanism housing. The rotary shaft has a first end that extends through a forward cap of the housing and is supported in a forward bearing. The forward end of the shaft is connected to a transmission arrangement adjacent the forward end of the transfer mechanism housing. The forward end of the rotary feed shaft is also attached to a material transport drive motor. The rotary shaft has a rearward end that extends beyond the rearward most end of the transfer mechanism housing, and is supported in a rear bearing. The rear bearing is supported on a rear bearing support that is attached to a rear end cap on the rearward end of the transfer mechanism housing.

A material spreader is arranged at the rearward end of the transfer mechanism housing along a lowermost portion thereof. A rotary spreader wheel or disc is arranged to rotate within the material spreader housing, on an axis, the material spreader housing having an upper portion which defines an opening through which granular material is transferred from the transfer mechanism housing to the spreader wheel.

The rotary feed shaft is supported in bearings that are arranged outside or beyond the ends of the transfer mechanism housing. The rotary feed shaft has a plurality of plates spaced apart thereon. Each plate, in a preferred embodiment, is of generally semicircular configuration. Each plate in its preferred embodiment is of planar configuration inclined and attached to the rotary shaft, at an angle of a range of between twenty-five degrees and forty-five degrees, preferably about thirty-three degrees. Each plate is preferably movably attached (by bolts or the like) to the shaft, and in an adjustably (angularly and longitudinally) opposed manner with respect to its adjacent plate, at about four to twelve inches distance therefrom, depending upon the size of the hopper and the nature of the granular material.

A plurality of spaced apart brackets may be attached between the inner portion of the side sloped walls and the spaced apart brackets may be connected by a cap rail extending thereacross.

Granular material, typically a mixture of sand and salt, (or fertilizer), is dropped through the opening in the upper portion of the tub or hopper and settles against the sloped walls thereof. The material transport drive motor at the front or forward edge of the hopper, is empowered so as to rotate the rotary feed shaft and cause the rotary plates to churn within the granular mixture in the transfer mechanism housing on the lowermost side of the hopper. The angular disposition of the individual plates on the rotary shaft effects a displacement of the granular material that falls gravitationally therebetween, from the hopper through the elongated slot along the upper edge of the transfer mechanism housing. Continued rotation of the rotary shaft and the rotation of the plates therewith effects a transmission of granular material within the transfer mechanism housing and rearwardly into the material spreader housing thus falling onto the material spreader wheel or disc to be distributed on the road surface beneath the truck as it travels down that road.

Thus, by virtue of the spaced apart and discontinuous yet adjustable nature of the individual plates effecting transmission of the granular material, granular material characteristics may be accommodated and accretion, buildup and jamming of those plates may be minimized. By virtue of the rotary feed shaft being supported in bearings arranged externally of each end of the elongated transfer mechanism housing, those bearing arrangements are not exposed to wear and degradation of the prior art, and thus are easily serviceable and have an almost indefinite life span.

Thus there has been shown a unique granular material displacement or transmission mechanism adapted and particularly well suited for the rigors of wintertime or cold weather distribution of sand and salt onto streets and roads or for differing types of fertilizer to be spread.

The invention thus comprises a granular material transport mechanism arranged in granular material flow communication with a granular material hopper, and is disposed on its lower side thereof, for distribution of the granular material from a spreader on a truck. The mechanism comprises an elongated containment housing for enclosing a rotary feed shaft. The rotary feed shaft has longitudinal ends that extend beyond the housing. A bearing support for the feed shaft is arranged adjacent each longitudinal end of the feed shaft and outside of the rotary feed shaft containment housing. An opening on a lower side of the containment housing permits the communicating of the granular material to the spreader arranged therebeneath. Pluralities of individual plates are disposed on the rotary shaft. The plates are preferably of planar configuration. The plates are spaced apart from one another on the rotary feed shaft. The plates are disposed at an angle of between 25 degrees and 45 degrees with respect to the longitudinal axis of the shaft. The plates may be disposed at an angle of about 33 degrees with respect to the longitudinal axis of the shaft. The plates preferably are of semicircular configuration. The plates may be of larger than semicircular configuration.

The invention also includes a method of transporting granular material in a sand distribution truck, from a sand hopper on said truck to a distribution spreader on said truck. The method includes the steps of: arranging a rotatable rotary feed shaft an elongated housing supported beneath said hopper; attaching a plurality of plates on the shaft; and rotating the shaft to transport the granular material from the hopper to the spreader. The plates are spaced apart from one another on said shaft. The plates are generally of semicircular configuration. The plates are planar and are attached to the shaft at an angle with respect to the longitudinal axis of the shaft. The angle extends through a range of about 25 degrees to about 45 degrees.

### BRIEF DESCRIPTION OF THE DRAWINGS

The objects and advantages of the present invention will become more apparent, when viewed in conjunction with the following drawings, in which:

FIG. 1 is a side elevational view of a hopper and spreader arrangement placed on the frame of a truck;

FIG. 2 is a view taken along the lines 2-2 of FIG. 1;

FIG. 2A is a plan view of the hopper on a truck;

FIG. 3 is a rear elevational view of the hopper and spreader arrangement shown in FIG. 1; and

FIG. 4 is a perspective view of a portion of the transfer mechanism arranged within the elongated housing beneath the hopper of the present invention.

### DESCRIPTION OF THE PREFERRED EMBODIMENT

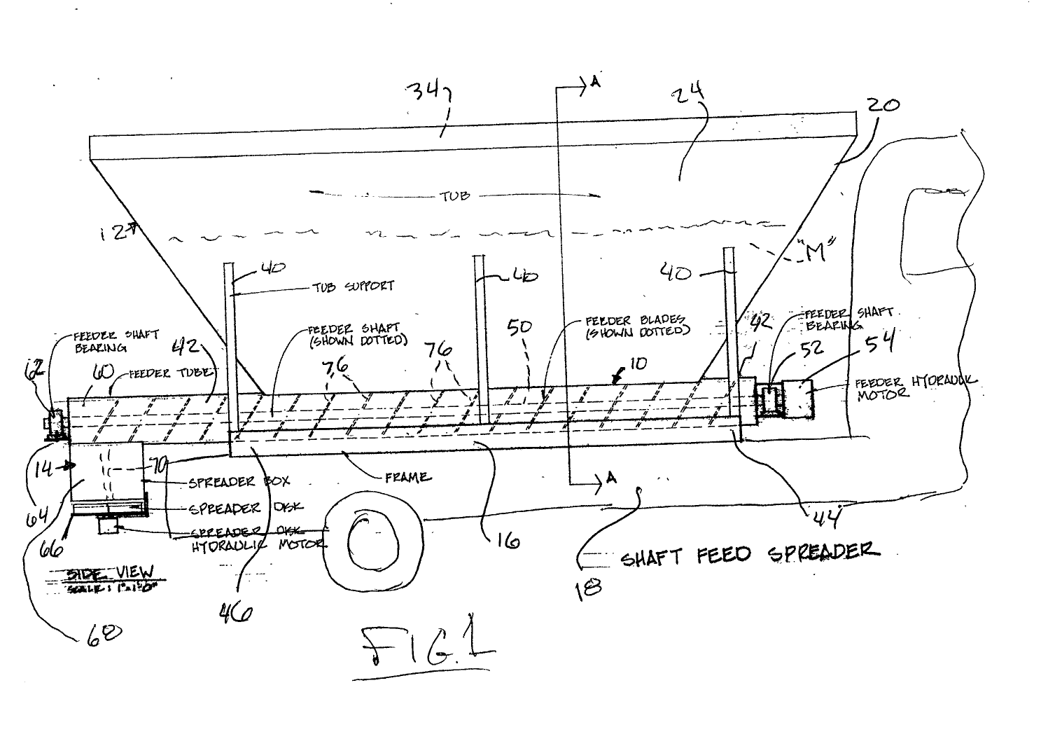

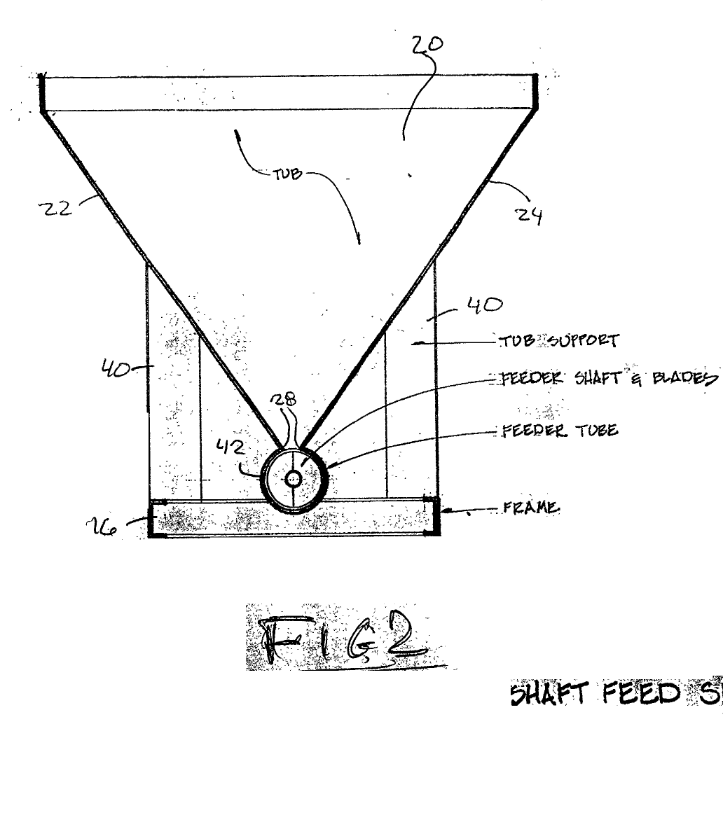

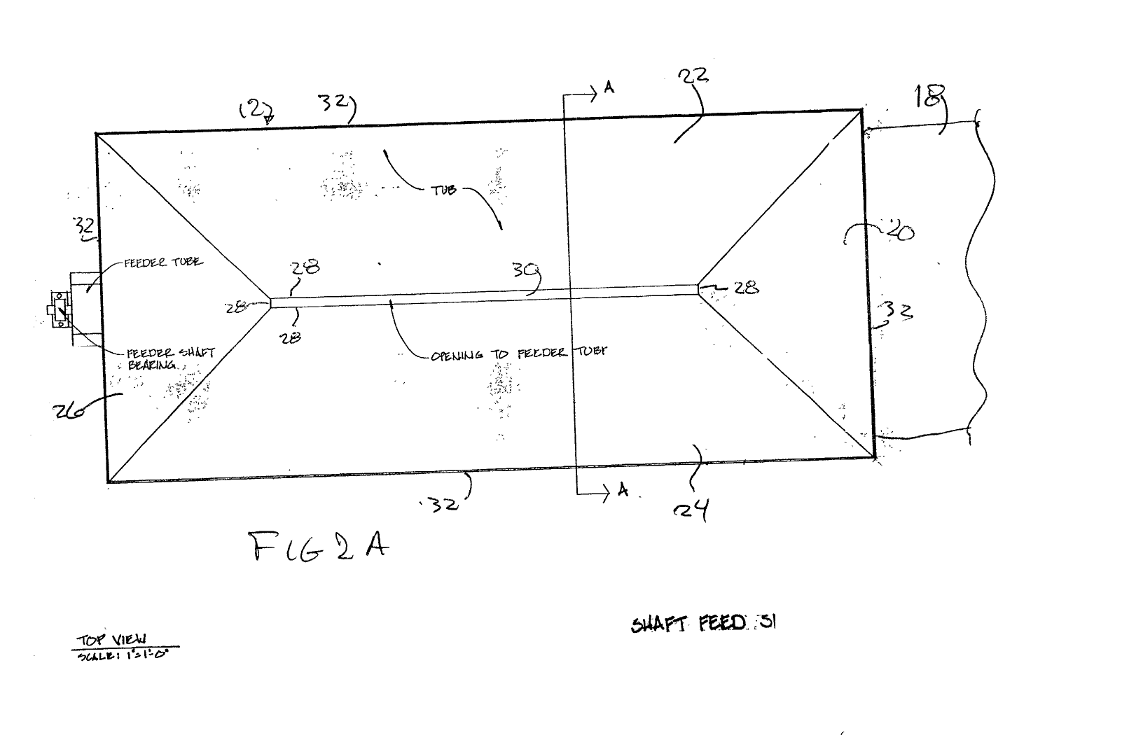

Referring now to the drawings in detail, and particularly to FIG. 1, there is shown the present invention which comprises a granular material transport arrangement 10 for use in supplying material “M” from a tub or hopper 12 to a spreader 14 attached to that hub or hopper 12. The hopper 12 of the present invention is typically arranged on an elongated frame 16 of a wheeled vehicle such as a sand truck 18. The hopper 12 is comprised of an elongated enclosure having a front sloped wall 20, a first side sloped wall 22, a second side sloped wall 24 and a rear sloped wall 26, each having a lowermost 28 edge that defines an elongated rectangular slot 30, as may be seen in FIGS. 1, 2 and 2A. Each sloped wall 20, 22, 24 and 26 has an uppermost edge 32 that defines the periphery of an open portion 34 for the loading of granular material within the tub or hopper 12.

The elongated rectangular slot 30, as shown in FIG. 2A defines an opening for the granular material transport mechanism 10 arranged at the lowermost portion of the elongated hopper 12.

A plurality of tub or hopper side support rails 40 may be arranged between the respective side sloped side walls 22 and 24 and the elongated frame 16 of the bed of the truck 18, as shown in FIGS. 1, 2 and 3, to properly support and hold the hopper 12 thereon.

The transport mechanism 10 is enclosed within a generally cylindrically shaped transfer mechanism housing 42 which extends from a front end 44 of the frame 16 to the rearward end 46 of the frame 16 on the truck 18. An elongated rotary feed shaft 50 extends longitudinally through the transfer mechanism housing 42, the rotary shaft 50 having a first end that is supported in a forward bearing 52 and is connected to a transmission and drive motor arrangement 54 adjacent the forward end of the transfer mechanism housing 42. The rotary shaft 50 has a rearward end that extends beyond the rearward most end 60 of the transfer mechanism housing 42, and is supported in a rear bearing 62. The rear bearing 62 is supported on a rear bearing support 64 attached to the transfer mechanism housing 42 and frame 16.

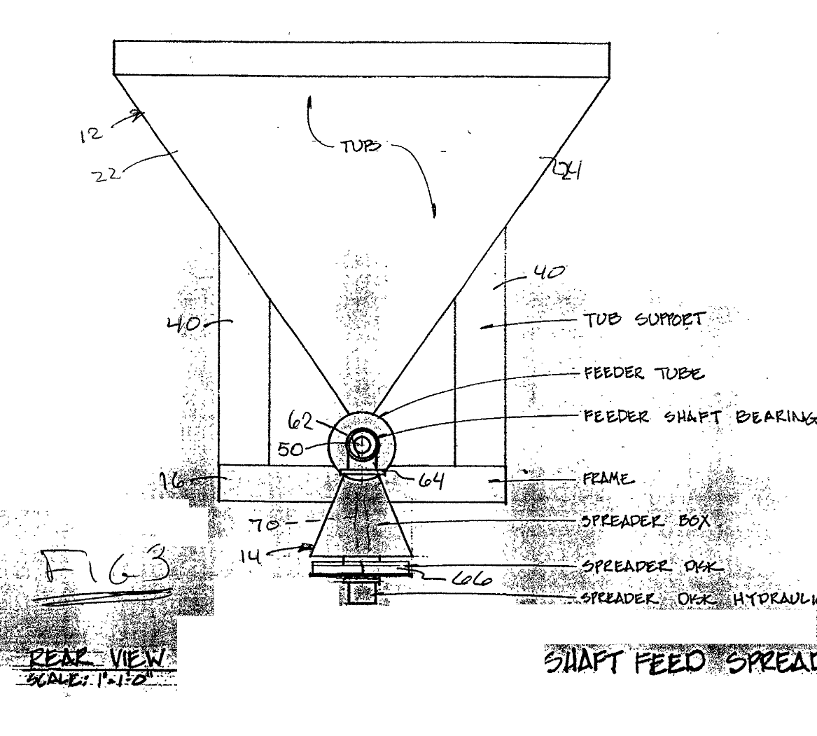

The material spreader 14 is arranged at the rearward end 60 of the transfer mechanism housing 42 along a lowermost portion thereof, as is shown in FIGS. 1 and 3. A rotary spreader wheel or disc 66 is arranged to rotate within a material spreader housing 68, on an axis 70, the material spreader housing 68 having an upper portion which defines an opening 72 through which granular material “M” is transferred through the transfer mechanism housing 42 to the spreader wheel 66.

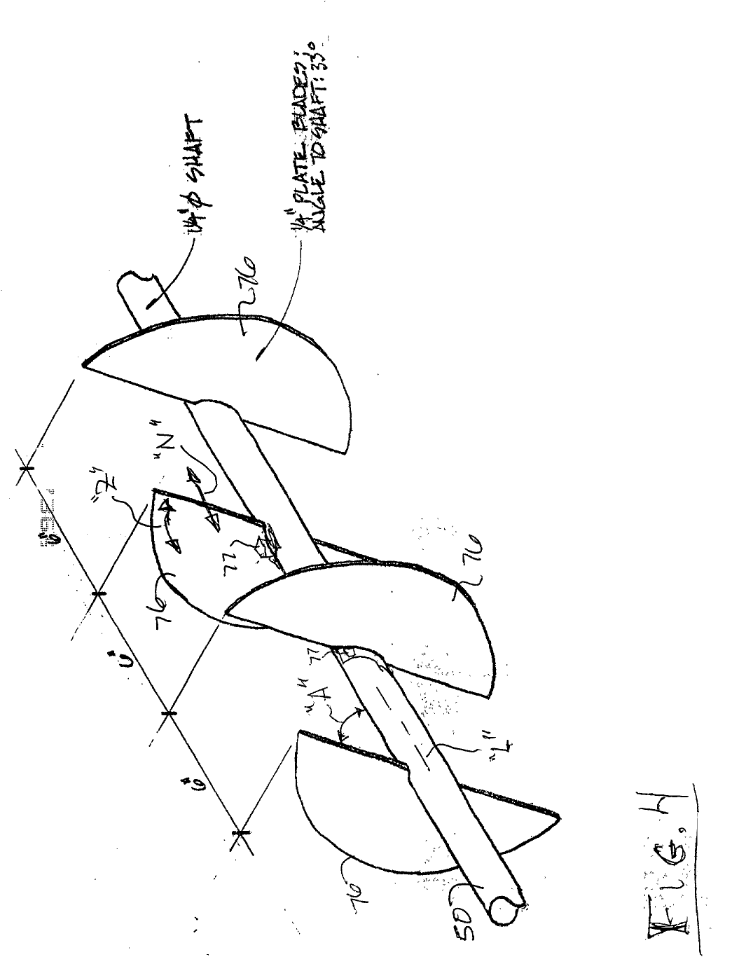

The rotary feed shaft 50 is supported in its bearings 52 and 62 that are arranged outside or beyond the ends of the transfer mechanism housing 42. The rotary feed shaft 50 has a plurality of plates 76 arranged in a spaced-apart manner thereon, as may be seen in FIG. 4. Each plate 76, in a preferred embodiment, is of semicircular configuration or may also be slightly larger by about 20 to 30 degrees. Each plate 76 in its preferred embodiment is of planar configuration and is inclined and attached to the rotary feed shaft 50, at an angle “A” of a range of between twenty-five degrees and forty-five degrees, preferably about thirty-three degrees with respect to the longitudinal axis “L” thereof. Each plate 76 is preferably of semicircular configuration and spaced from its adjacent plate, in an alternatingly opposed manner at about four to twelve inches distance therefrom as is shown in FIG. 4. A further embodiment of the present invention teaches the angular and longitudinal displaceability of the plates 76 with respect to one another, permitted by adjustable bolts 77 or the like, and indicated by arrows “Z” and “N”.

Granular material “M”, typically a mixture of sand and salt, is dropped through the opening 34 in the upper portion of the tub or hopper 12 and settles against the sloped walls 20, 22, 24 and 26 thereof. The material transport drive motor 54 at the front or forward edge of the hopper 12 is empowered so as to rotate the rotary shaft 50 and cause the rotary plates 76 to churn within the granular mixture “M” in the transfer mechanism housing 42 fallen through the elongated slot 30 on the lowermost side of the hopper 12. The angular disposition of the plates 76 on the rotary shaft 50 effects a displacement of the granular material “M” that falls gravitationally therebetween, from the hopper through the elongated slot 30 along the upper edge of the transfer mechanism housing 42. Continued rotation of the rotary shaft 50 and the rotation of the plates 76 therewith effects a transmission of granular material “M” within the transfer mechanism housing 42 and rearwardly into the material spreader housing 68 thus falling onto the material spreader wheel 66 to be distributed on the road surface beneath the truck 18 as it travels down that road.

Thus, by virtue of the spaced-apart and discontinuous nature of the plates 76 effecting transmission of the granular material “M”, granular material accretion, buildup and jamming of those plates are minimized. By virtue of the rotary feed shaft 50 being supported in bearings 52 and 62 arranged externally of each end of the elongated transfer mechanism housing 42, those bearing arrangements 52 and 62 are not exposed to wear and degradation of the prior art, and thus have an indefinite life span.

Thus there has been shown a unique granular material displacement or transmission mechanism adapted and particularly well suited for the rigors of wintertime or cold weather distribution of sand and salt onto streets and roads.

We claim:

1. A granular material transport mechanism arranged in granular material flow communication with a granular material hopper, and disposed on its lower side thereof, for distribution of said granular material from a spreader on a truck, said mechanism comprising:
an elongated containment housing for enclosing a rotary feed shaft, said rotary feed shaft having longitudinal ends that extend beyond said housing;
a bearing support for said feed shaft arranged adjacent each longitudinal end of said feed shaft and outside of said containment housing; and
an opening on a lower side of said containment housing for communicating said granular material to said spreader arranged therebeneath.

2. The granular material mechanism as recited in claim 1, wherein a plurality of individual plates is disposed on said rotary shaft.

3. The granular material mechanism as recited in claim 2, wherein said plates are of planar configuration.

4. The granular material mechanism as recited in claim 2, wherein said plates are spaced apart from one another on said rotary feed shaft.

5. The granular material mechanism as recited in claim 2, wherein said plates are disposed at an angle of between 25 degrees and 45 degrees with respect to the longitudinal axis of said shaft.

6. The granular material mechanism as recited in claim 5, wherein said plates are disposed at an angle of about 33 degrees with respect to the longitudinal axis of said shaft.

7. The granular material mechanism as recited in claim 2, wherein said plates are of semicircular configuration.

8. The granular material mechanism as recited in claim 7, wherein said plates are of larger than semicircular configuration.

9. The granular material mechanism as recited in claim 2, wherein said plates are movably adjustable.

10. A method of transporting granular material in a sand distribution truck, from a sand hopper on said truck to a distribution spreader on said truck, comprising the steps of:
arranging a rotatable rotary feed shaft an elongated housing supported beneath said hopper;
attaching a plurality of plates on said shaft; and
rotating said shaft to transport said granular material from said hopper to said spreader.

11. The method as recited in claim 10, including the step of:
moving said plates on said shaft to accommodate changes in granular material churned thereby.

12. The method as recited in claim 10, wherein said plates are spaced apart from one another on said shaft.

13. The method as recited in claim 10, wherein said plates are generally of semicircular configure configuration.

14. The method as recited in claim 10, wherein said plates are planar and are attached to said shaft at an angle with respect to the longitudinal axis of said shaft.

15. The method as recited in claim 14, wherein said angle extends through a range of about 25 degrees to about 45 degrees.

16. A granular material transport mechanism arranged in granular material flow communication with a granular material hopper, and disposed on its lower side thereof, for distribution of said granular material from a spreader on a truck, said mechanism comprising:
an elongated containment housing for enclosing a rotary feed shaft, said rotary feed shaft having longitudinal ends that extend beyond said housing;
a bearing support for said feed shaft arranged adjacent each longitudinal end of said feed shaft and outside of said containment housing;
an opening is arranged on a lower side of said containment housing for communicating said granular material to said spreader arranged therebeneath, and wherein a plurality of individual plates are disposed on said rotary shaft, said plates being of planar configuration, said plates being spaced apart from one another on said rotary feed shaft, said plates being disposed at an angle of between 25 degrees and 45 degrees with respect to the longitudinal axis of said shaft and wherein said plates are of semicircular configuration.
